(19) United States
(12) Patent Application Publication
(10) Pub. No.: US 2022/0055917 A1
(43) Pub. Date: Feb. 24, 2022

(54) PORTABLE WATER BOTTLE WITH FILTER AND TEMPERATURE CONTROL MODULE

(71) Applicant: Yuan Chen HSIAO, New Taipei City (TW)

(72) Inventor: Yuan Chen HSIAO, New Taipei City (TW)

(21) Appl. No.: 16/998,950

(22) Filed: Aug. 20, 2020

(51) Int. Cl. C02F 1/00; B01D 35/30; A47J 36/24; F25D 11/00

(52) U.S. Cl. CPC C02F 1/002; B01D 35/30; A47J 36/2483; F25D 2331/803; C02F 2307/02; F25D 2400/12; F25D 2400/02; F25D 11/003

(57) ABSTRACT

A portable water bottle has a bottle body, a lid assembly detachably connected to an upper end of the bottle body, a filter mounted in the lid assembly, a base detachably connected to a lower end of the bottle body, a temperature control module mounted in the base, and a power module mounted in the base. Liquid stored in the bottle body can be filtered by the filter when being poured out of the bottle body, so as to allow a user can drink the liquid directly and immediately. Moreover, the temperature control module is capable of heating or cooling down the liquid in the bottle body, so as to provide the user with the liquid having the temperature that is suitable for ambient it temperature or physical conditions of the user.

### BACKGROUND OF THE INVENTION

### 1. Field of the invention

The present invention relates to a portable water bottle, especially to a portable water bottle that is able to filter out impurities in a liquid and adjust temperature of the liquid.

### 2. Description of the Prior Art(s)

Water in the human body is helpful in transporting nutrition, promoting metabolism, regulating body temperature, lubricating joints, retaining elasticity of skin, and discharging metabolic wastes from the human body, Therefore, the water is an important substance to keep the human body work normally. When running, hiking, mountain climbing, or doing sports or exercises that would sweat a lot, it s especially necessary to drink water at any time to avoid physical discomfort due to heatstroke or dehydration. However, during multi-day mountaineering, in order to reduce weight that needs to be carried, it is unable to carry too much drinking water, yet there may be parasites or germs spreading in streams or lakes. Thus, if a user drink water from the streams or the lakes directly, the user may get sick.

Since a conventional portable water bottle for storing drinking water is unable to filter out impurities in the water, it is necessary to filter or boil the water from the streams or the lakes before filling the water into the conventional portable water bottle. However, process of filtering and boiling the water is complicated and time-consuming, such that it is unable to allow the user to drink water immediately. Moreover, the conventional portable water bottle is also unable to cool or heat water stored therein. Consequently, the user is unable to drink the water which temperature is suitable for ambient temperature or physical conditions of the user.

To overcome the shortcomings, the present invention provides a portable water bottle with filter and temperature control module to mitigate or obviate the aforementioned problems.

### SUMMARY OF THE IVENTION

The main objective of the present invention is to provide a portable water bottle that is able to filter out impurities in a liquid and adjust temperature of the liquid. The portable water bottle has a bottle body, a lid assembly detachably connected to and covering an upper end of the bottle body, a filter mounted in the lid assembly, a base detachably connected to and covering a lower end of the bottle body, a temperature control module mounted in the base, and a power module mounted in the base and electrically connected to the temperature control module.

Liquid that is needed to be filtered is stored in the bottle body and then is poured out of the bottle body through the outlet hole of the upper lid of the lid assembly, so as to be filtered by the filter in the lid assembly. Thus, a user can drink the liquid directly and immediately. Moreover, the temperature control module mounted on the lower end of the bottle body is capable of further heating or cooling down the liquid in the bottle body, so as to provide the user with the liquid having the temperature that is suitable for ambient temperature or physical conditions of the user.

Other objectives, advantages and novel features of the invention will become more apparent from the following detailed description when taken in conjunction with the accompanying drawings.

### BRIEF DESCRIPTION OF THE DRAWINGS

FIG. 1 is a cross-sectional side view of a portable water bottle in accordance with the present invention;

FIG. 2 is an exploded cross-sectional side view of the portable water bottle in FIG. 1;

FIG. 3 is a cross-sectional side view of a lid assembly of the portable water bottle in FIG. 1;

FIG. 4 is a cross-sectional side view of a base of the portable water bottle in FIG. 1;

FIG. 5 is a schematic view of a temperature control module and a power module of the portable er bottle in FIG. 1; and

FIG. 6 is a cross-sectional side view of another embodiment of a base of a portable water bottle in accordance with the present invention.

### DETAILED DESCRIPTION OF THE PREFERRED EMBODIMENTS

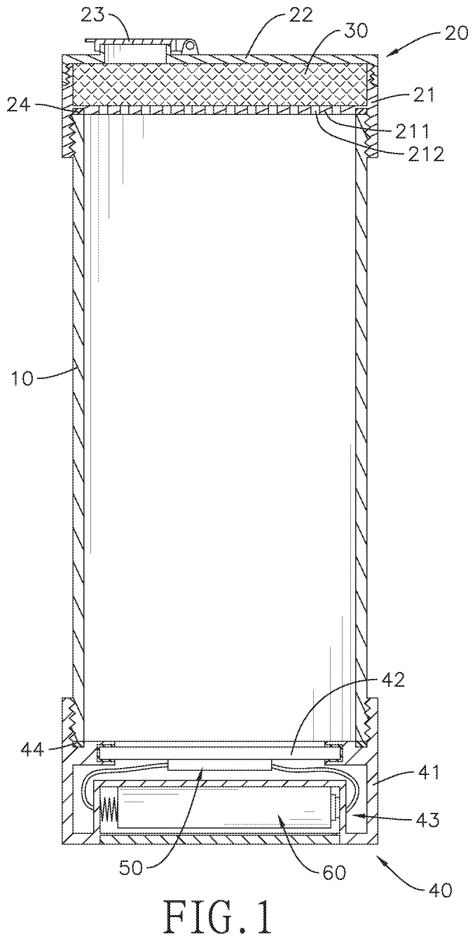

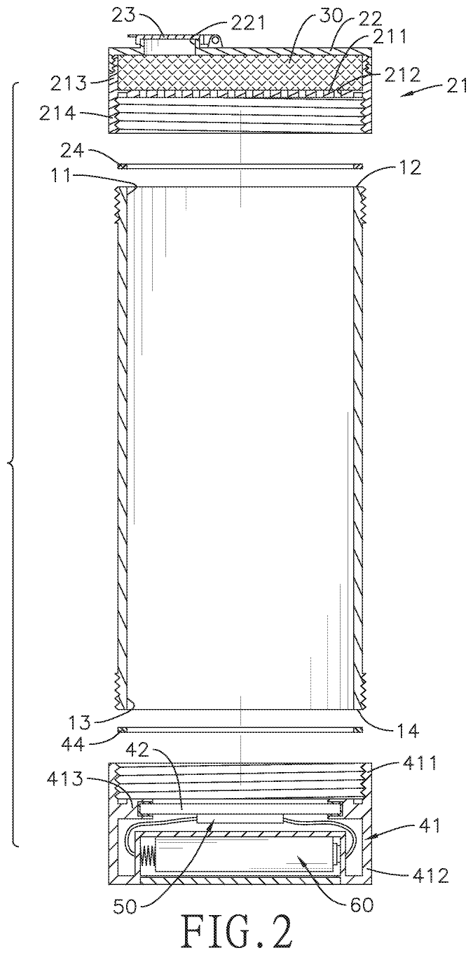

With reference to FIGS. 1 and 2, a portable water bottle in accordance with the present invention comprises a bottle body 10, a lid assembly 20, a filter 30, a base 40, a temperature control module 50, and a power module 60. The bottle body 10 has an upper opening 11_{;} an upper end edge 12, a lower opening 13, and a lower end edge 14. The upper opening 11 is defined through an upper end of the bottle body 10. The upper end edge 12 is defined around the upper opening 11 of the bottle body 10. The lower opening 13 is defined through a lower end of the bottle body 10. The lower end edge 14 is defined around the lower opening 13 of the bottle body 10.

In the preferred embodiment as shown in the figures of the present invention, the bottle body 10 is, but not limited to, elongated and cylindrical However, the bottle body 10 may be long or short. In addition to circular, the bottle body may also be triangular, rectangular, hexagonal, octagonal, or any other irregular shapes in cross-section.

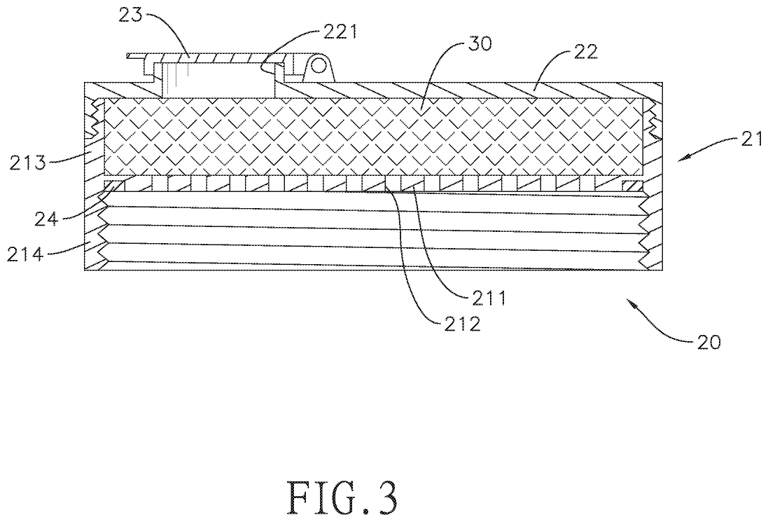

With further reference to FIG. 3, the lid assembly 20 is detachably connected to and covers the upper end of the bottle body 10 and covers the upper opening 11 of the bottle body 10. The lid assembly 20 includes a main lid 21, an upper lid 22, an outlet hole cover 23, and a first sealing ring 24. The main lid 21 is detachably connected to the upper end of the bottle body 10, and has a partition 211, an upper annular sidewall 213 and a lower annular sidewall 214. The partition 211 has an upper surface, a lower surface, and multiple inlet holes 212 separately formed through the partition 211. The upper annular sidewall 213 is formed on and protrudes from the upper surface of the partition 211. The lower annular sidewall 214 is formed on and protrudes from the lower surface of the partition 211 and is detachably connected to the upper end of the bottle body 10. The inlet holes 211 of the partition 211 are surrounded by the upper annular sidewall 213 and the lower annular sidewall 214.

The upper lid 22 is detachably connected to the upper annular sidewall 13 of the main lid 21 and has an outlet hole 221 formed through the upper lid 22. The outlet hole cover 23 is detachably connected to the upper lid 22 and selectively covers the outlet hole 221 of the upper lid 22. The first sealing ring 24 is embedded in the lower surface of the partition 211 of the main lid 21. As shown in FIG. 1, when the main lid 21 covers on the upper end of the bottle body 10, the upper end edge 12 of the bottle body 10 abuts against the first sealing ring 24, so as to ensure that liquid inside the bottle body 10 does not leak from a portion where the main lid 21 and the bottle body 10 are connected with each other.

The filter 30 is mounted in an upper mounting room formed between the partition 211 of the main lid 21 and the upper lid 22 and is used for filtering out impurities in the liquid.

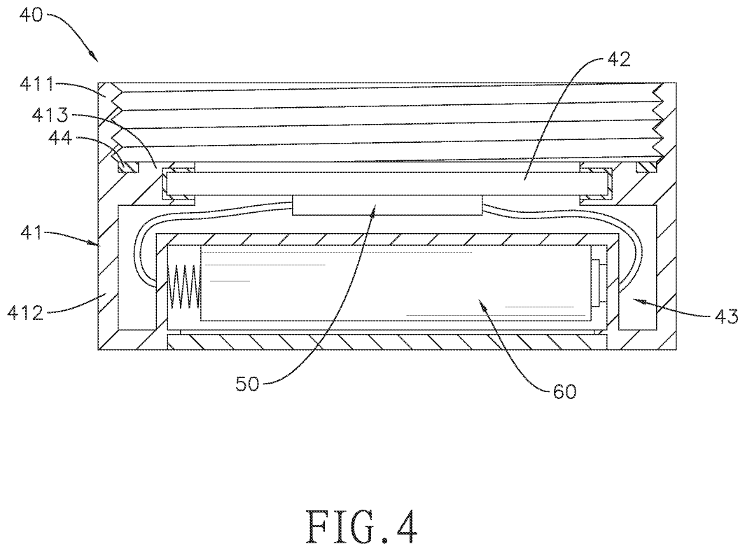

With further reference to FIG. 4, the base 40 is detachably connected to the lower end of the bottle body 10 and covers the lower opening 13 of the bottle body 10. The base 40 has an annular sidewall 41 and a thermal conduction panel 42. The annular sidewall 41 has an upper end 411 and a lower end 412. The upper end 411 of the annular sidewall 41 is detachably connected to the lower end of the bottle body 10. The thermal conduction panel 42 is surrounded by the annular sidewall 41, is disposed between the upper end 411 of the annular sidewall 41 and the lower end 412 of the annular sidewall 41, and has an annular edge. The annular edge of the thermal conduction panel 42 is sealingly attached to the annular sidewall 41. A lower mounting room 43 is enclosed by the thermal conduction panel 42 and the lower end 412 of the annular sidewall 41.

In the preferred embodiment, an inner flange 413 is formed on an inner surface of the annular sidewall 41 of the base 40. The annular edge of the thermal conduction panel 42 is sealingly attached to the inner flange 413.

Otherwise, the annular edge of the thermal conduction panel 42 may also be sealingly attached to the inner surface of the annular sidewall 41 directly.

Moreover, the inner flange 413 has an upper surface facing forward the upper end 411 of the annular sidewall 41 and the base 40 may further has a second sealing ring 44. The second sealing ring 44 is embedded in the upper surface of the inner flange 413. As shown in FIG. 1, when the base 40 covers on the lower end of the bottle body 10, the lower end edge 14 of the bottle body 10 abuts against the second sealing ring 44, so as to ensure that the liquid inside the bottle body 10 does not leak from a portion where the upper end 411 of the annular sidewall 41 of the base 40 and the bottle body 10 are connected with each other.

In the preferred embodiment, the upper end of the bottle 10 and the lower annular sidewall 214 of the main lid 21 are detachably connected with each other via threads, the upper lid 22 and the upper annular sidewall 213 of the main lid 21 are detachably connected with each other via threads, and the lower end of the bottle body 10 and the upper end 411 of the annular sidewall of the base 40 are also detachably connected with each other via threads. However, connecting structures between the upper end of the bottle 10 and the lower annular sidewall 214 of the main lid 21, between the upper lid 22 and the upper annular sidewall 213 of the main lid 21, and between the lower end of the bottle body 10 and the upper end 411 of the annular sidewall of the base 40 are not limited to the threads, and may be other detachable connecting structures, such as buckle structures, each of which has protrusions and recesses engaging with each other, hook and loop fasteners, whose common name is “Velcro”, or binding structures.

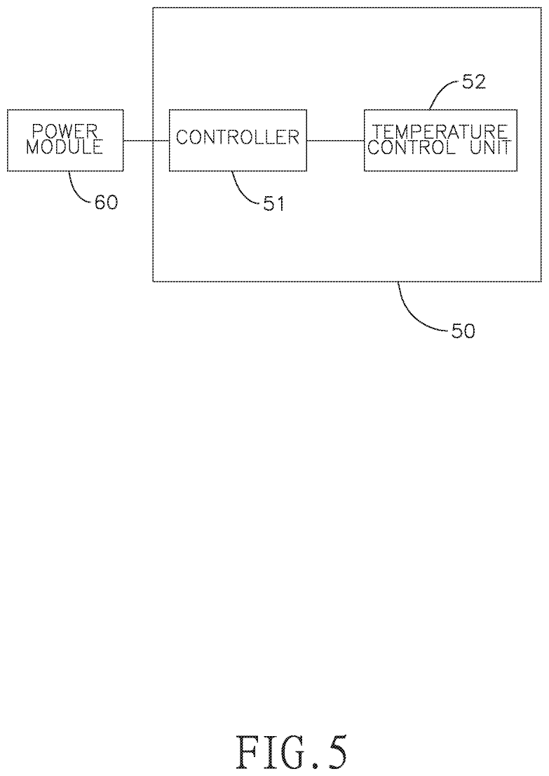

With further reference to FIG. 5, the temperature control module 50 is mounted in the lower mounting room 43 of the base 40 and includes a controller 51 and at least one temperature control unit 52, 52A. The at least one temperature control unit 52, 52A is electrically connected to the controller 51 and is attached to the thermal conduction panel 42. The at least one temperature control unit 52, 52A is capable of cooling down or heating the thermal conduction panel 42, so as to adjust temperature of the thermal conduction panel 42.

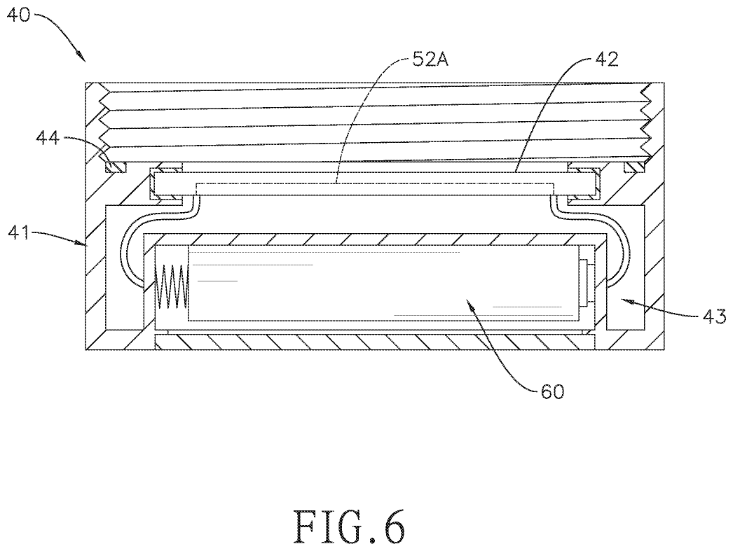

Preferably, each of the at least one temperature control unit 52 may be a thermoelectric cooling chip. The thermoelectric cooling chip is able to conduct heat away from the thermal conduction panel 42 to cool down the thermal conduction panel 42, or heat the thermal conduction panel 42 to increase the temperature of the thermal conduction panel 42. However, each of the at least one temperature control unit 52 is not limited to the thermoelectric cooling chip, and may heat the thermal conduction panel 42 by electrical resistance heating or electromagnetic induction heating. Specifically, as shown in FIG. 6, each of the at least one temperature control unit 52A is a resistance wire. The resistance wire is embedded in the thermal conduction panel 42 and is able to heat the thermal conduction panel 42.

The power module 60 is also mounted in the lower mounting room 43 of the base 40 and is electrically connected to the controller 51, so as to provide electrical power required for operation of the controller 51 and the at least one temperature control unit 52, 52A.

When using the portable water bottle of the present invention, the liquid, such as water from taps, streams or lakes that is needed to be filtered, is stored in the bottle body 10 and then is poured out of the bottle body 10 through the outlet hole 221 of the upper lid 22 of the lid assembly 20. As pouring the liquid, the liquid flows through the filter 30 in the lid assembly 20 to filter out the impurities in the liquid. Thus, a user can drink the liquid directly and immediately. Moreover, the temperature control module 50 mounted on the lower end of the bottle body 10 is capable of further heating or cooling down the liquid in the bottle body 10, so as to provide the user with the liquid having the temperature that is suitable for ambient temperature or physical conditions of the user.

Even though numerous characteristics and advantages of the present invention have been set forth in the foregoing description, together with details of the structure and features of the invention, the disclosure is illustrative only. Changes may be made in the details, especially in matters of shape, size, and. arrangement of parts within the principles of the invention to the full extent indicated by the broad general meaning of the terms in which the appended claims are expressed.

What is claimed is:

1. A portable water bottle comprising:
a bottle body;
a lid assembly detachably connected to and covering an upper end of the bottle body;
a filter mounted in the lid assembly;
a base detachably connected to and covering a lower end of the bottle body;
a temperature control module mounted in the base; and
a power module mounted in the base and electrically connected to the temperature control module.

2. The portable water bottle as claimed in claim 1, wherein
the lid assembly includes
a main lid detachably connected to the upper end of the bottle body, and having
a partition having multiple inlet holes separately formed through the partition;
an upper annular sidewall formed on and protruding from an upper surface of the partition; and
a lower annular sidewall formed on and protruding from a lower surface of the partition and detachably connected to the upper end of the bottle body, wherein the inlet holes of the partition are surrounded by the upper annular sidewall and the lower annular sidewall;
an upper lid detachably connected to the upper annular sidewall of the main lid and having an outlet hole formed through the upper lid; and
an outlet hole cover detachably connected to the upper lid and selectively covering the outlet hole of the upper lid; and
the filter is mounted in an upper mounting room formed between the partition of the main lid and the upper lid.

3. The portable water bottle as claimed in claim 1, wherein
the base has
an annular sidewall having
an upper end detachably connected to the lower end of
the bottle body; and
a lower end; and
a thermal conduction panel surrounded by the annular sidewall and having an annular edge, and the annular edge of the thermal conduction panel sealingly attached to the annular sidewall, wherein a lower mounting room is enclosed by the thermal conduction panel and the lower end of the annular sidewall;
the temperature control module is mounted in the lower mounting room of the base and includes
a controller; and
at least one temperature control unit electrically connected to the controller and attached to the thermal conduction panel for adjusting temperature of the thermal conduction panel; and
the power module mounted in the lower mounting room of the base and electrically connected to the controller.

4. The portable water bottle as claimed in claim 2, wherein
the base has
an annular sidewall having
an upper end detachably connected to the lower end of the bottle body; and
a lower end; and
a thermal conduction panel surrounded by the annular sidewall and having an annular edge, and the annular edge of the thermal conduction panel sealingly attached to the annular sidewall, wherein a lower mounting room is enclosed by the thermal conduction panel and the lower end of the annular sidewall;
the temperature control module is mounted in the lower mounting room of the base and includes
a controller; and
at least one temperature control unit electrically connected to the controller and attached to the thermal conduction panel for adjusting temperature of the thermal conduction panel; and
the power module mounted in the lower mounting room of the base and electrically connected to the controller.

5. The portable water bottle as claimed in claim 3, wherein each of the at least one temperature control unit is a thermoelectric cooling chip.

6. The portable water bottle as claimed in claim 4, wherein each of the at least one temperature control unit is a thermoelectric cooling chip.

7. The portable water bottle as claimed in claim 3, wherein each of the at least one temperature control unit heats the thermal conduction panel by electrical resistance heating.

8. The portable water bottle as claimed in claim 4, wherein each of the at least one temperature control unit heats the thermal conduction panel by electrical resistance heating.

9. The portable water bottle as claimed in claim 3, wherein the lid assembly further includes a first sealing ring embedded in a lower surface of the partition of the main lid;
when the main lid covers on the upper end of the bottle body, an upper end edge of the bottle body abuts against the first sealing ring.

10. The portable water bottle as claimed in claim 4, wherein the lid assembly further includes a first sealing ring embedded in the lower surface of the partition of the main lid;
when the main lid covers on the upper end of the bottle body, an upper end edge of the bottle body abuts against the first sealing ring.

11. The portable water bottle as claimed in claim 3, wherein an inner flange is formed on an inner surface of the annular sidewall of the base; and
the annular edge of the thermal conduction panel is sealingly attached to the inner flange.

12. The portable water bottle as claimed in claim 4, wherein an inner flange is formed on an inner surface of the annular sidewall of the base; and
the annular edge of the thermal conduction panel is sealingly attached to the inner flange.

13. The portable water bottle as claimed in claim 11, wherein
the inner flange has an upper surface facing forward the upper end of the annular sidewall; and
the base has a second sealing ring embedded in the upper surface of the inner flange;
when the base covers on the lower end of the bottle body, the lower end edge of the bottle body abuts against the second sealing ring.

14. The portable water bottle as claimed in claim 12, wherein
the inner flange has an upper surface facing forward the upper end of the annular sidewall; and
the base has a second sealing ring embedded in the upper surface of the inner flange;
when the base covers on the lower end of the bottle body, the lower end edge of the bottle body abuts against the second sealing ring.
